(19) United States
(12) Patent Application Publication
(10) Pub. No.: US 2025/0369518 A1
(43) Pub. Date: Dec. 4, 2025

(54) FLAP DEVICE FOR AN INTERNAL COMBUSTION ENGINE

(71) Applicant: PIERBURG GMBH, NEUSS (DE)

(72) Inventors: LARS HEINEMANN, NEUSS (DE); RINGO UHLENDORF, NEUSS (DE); FRANK SOLZBACHER, NEUSS (DE)

(73) Assignee: PIERBURG GMBH, NEUSS (DE)

(21) Appl. No.: 18/867,453

(22) PCT Filed: May 24, 2022
(86) PCT No.: PCT/EP2022/064108

§ 371 Date: Nov. 20, 2024

(51) Int. Cl. F16K 1/22; H01M 8/04082; H01M 8/04746

(52) U.S. Cl. CPC F16K 1/221; H01M 8/04201; H01M 8/04753; H01M 2250/20

(57) ABSTRACT

A flap device for a fuel cell system includes a flow housing, a flap shaft projecting into a flow channel, a flap body arranged in the flow channel which is attached to the flap shaft, and a tolerance compensation element. The flap shaft is rotatable about a longitudinal axis. The flap body is adjustable together with the flap shaft at least between a closed and an open position. During an assembly of the flap device, the tolerance compensation element can be fastened to the flap shaft in different positions to bridge a gap between the flap shaft and the flap body, whereby the flap body contacts the tolerance compensation element, or the tolerance compensation element is fastened to the flap body in different positions transversely to the longitudinal axis to bridge a gap between the flap shaft and the flap body, whereby the flap shaft contacts the tolerance compensation element.

### CROSS REFERENCE TO PRIOR APPLICATIONS

This application is a U.S. National Phase application under 35 U.S.C. § 371 of International Application No. PCT/EP2022/064108 filed on May 24, 2022. The International Application was published in German on Nov. 30, 2023 as WO 2023/227207 A1 under PCT Article 21(2).

### FIELD

The present invention relates to a flap device for a fuel cell system, the flap device having a flow housing that defines at least one flow channel, a flap shaft that extends into the flow channel which can be rotated around a longitudinal axis, and a flap body which is arranged in the flow channel which is attached to the flap shaft, wherein the flap body can be adjusted together with the flap shaft at least between a closed position and an open position.

### BACKGROUND

Such flap devices are in particular known in connection with internal combustion engines where the flap devices are arranged on an exhaust gas line extending out from the internal combustion engine and are used, for example, as exhaust gas damper flaps or as exhaust gas recirculation valves in low-pressure or high-pressure exhaust gas circuits. Such flap devices are also used in an air intake duct of the internal combustion engine, in particular as a throttle flap. Such a flap device is described, for example, in EP 3 379 070 A1. The flap devices usually comprise a flap shaft and a flap body, wherein the flap shaft projects into a flow housing and the flap body attached to the flap shaft is arranged in the flow housing, i.e., within a flow channel defined by the flow housing. The flap shaft and the flap body can be adjusted or turned by an actuator, in particular by an electric actuator, between at least an open position and a closed position. A flow cross-section of the flow channel is open to a fluid in the open position, such as air or exhaust gas. The flow cross-section of the flow channel is closed by the flap body in the closed position, whereby the flap body contacts a counter-sealing surface formed on the flow housing via a sealing surface.

Such flap devices are also known in the field of fuel cell systems where the flap devices are used to control an air flow into a cathode space. The sealing in a closed position of the flap device, i.e., the complete shut-off of the air, is here particularly important. Such a flap device is described, for example, in DE 102 04 787 A1.

The flap shaft of the flap device is usually rotatably mounted on the flow housing, whereby the position of the sealing surface of the flap body in the closed position is rigidly defined by the position of the flap shaft. The corresponding counter-sealing surface is usually formed on the flow housing and is therefore also rigidly defined. Manufacturing and assembly tolerances exist in all application areas of the flap device, which manufacturing and assembly tolerances, in particular in the area of the bearing of the flap shaft, the attachment of the flap body to the flap shaft and to the counter sealing surface, can lead to the sealing surface and the counter-sealing surface being spaced apart from one another in the closed position of the flap device, i.e., not being in contact with one another, thereby causing a high, unwanted leakage flow.

### SUMMARY

An aspect of the present invention is to provide a valve device that can reduce leakage when the valve device is closed.

In an embodiment, the present invention provides a flap device for a fuel cell system. The flap device includes a flow housing which defines at least one flow channel, a flap shaft which projects into the at least one flow channel, a flap body which is arranged in the at least one flow channel and which is attached to the flap shaft, and a tolerance compensation element. The flap shaft is configured to be rotated by an actuator between a plurality of positions about a longitudinal axis. The flap body is configured to be adjusted together with the flap shaft at least between a closed position and an open position. During an assembly of the flap device, the tolerance compensation element is configured so that it can be fastened to the flap shaft in different positions transversely to the longitudinal axis of the flap shaft so as to bridge a gap between the flap shaft and the flap body, the flap body contacting the tolerance compensation element transversely to the longitudinal axis of the flap shaft, or the tolerance compensation element is configured so that it can be fastened to the flap body in different positions transversely to the longitudinal axis of the flap shaft so as to bridge a gap between the flap shaft and the flap body, the flap shaft contacting the tolerance compensation element transversely to the longitudinal axis of the flap shaft.

### BRIEF DESCRIPTION OF THE DRAWINGS

The present invention is described in greater detail below on the basis of embodiments and of the drawings in which:

FIG. 1 shows a longitudinal section of a flap device of the present invention; and

FIG. 2 shows a cross-section of the flap device from FIG. 1.

### DETAILED DESCRIPTION

The present invention provides a tolerance-compensating element wherein, when the flap device is being assembled, the tolerance-compensating element can be fastened to the flap shaft in different positions, transversely to the longitudinal axis of the flap shaft, in order to bridge a gap between the flap shaft and the flap body, wherein the tolerance compensation element can be fastened to the flap body in different positions at right angles to the longitudinal axis of the flap shaft, wherein the flap shaft is in contact with the tolerance compensation element at right angles to the longitudinal axis, or the tolerance compensation element can be fastened to the flap body at right angles to the longitudinal axis of the flap shaft in different positions in order to bridge a gap between the flap shaft and the flap body, wherein the flap shaft is in contact with the tolerance compensation element at right angles to the longitudinal axis. This allows the manufacturing tolerances and assembly tolerances to be compensated for in a simple manner and leakage flow to be reduced or completely avoided when the valve body is in the closed position. The tolerance compensation element can be individually adjusted for each individual valve device during the assembly process thereby reliably compensating for the manufacturing and assembly tolerances that vary between the individual valve devices. By adjusting the tolerance compensation element, the sealing surface of the flap body can be displaced transversely to the longitudinal axis of the flap shaft until the sealing surface is in contact with the counter-sealing surface.

The tolerance compensation element can, for example, comprise a thread, and the flap shaft or the flap body can, for example, comprise a counter-thread which is complementary to the thread, so that the tolerance compensation element can be adjusted via a rotational movement around a longitudinal axis of the tolerance compensation element. The tolerance compensation element can thereby be adjusted simply by twisting, i.e., it can be displaced in both directions depending on the direction of rotation.

In an embodiment of the present invention, the tolerance compensation element can, for example, be configured in the manner of a sleeve and is arranged in a through opening of the flap shaft or the flap body, wherein the tolerance compensation element comprises an external thread on an outer circumferential surface and an internal thread which is complementary to the external thread is provided on a circumferential surface of the through opening. The sleeve-like tolerance-compensating element is alternatively arranged on a protrusion of the flap body or the flap shaft, wherein the tolerance-compensating element comprises an internal thread and an internal thread complementary to the external thread is provided on the protrusion. The tolerance-compensating element can thereby be arranged on the flap body or on the flap shaft in a simple and cost-effective manner.

The sleeve-like tolerance compensation element is alternatively arranged on a protrusion or in a through opening of the flap body or the flap shaft so that the tolerance compensation element is positioned in a gap-bridging position and is welded or adhesively bonded to the flap body or the flap shaft. Another alternative is that the tolerance-compensating element is attached, in particular screwed, to the flap body and is welded or adhesively bonded to the flap shaft, or that the tolerance-compensating element is attached, in particular screwed, to the flap shaft and is adhesively bonded or welded to the flap body so that the tolerance compensation element is positioned in a gap-bridging position and is adhesively bonded or welded to the flap body or the flap shaft. The tolerance compensation element can also be easily and inexpensively arranged on the flap body or the flap shaft using the two alternatives.

The fastening element can, for example, be a screw element, wherein the screw element is arranged coaxially with the sleeve-like tolerance compensation element. The screw element extends through the sleeve-like tolerance compensation element in the assembled state. When the tolerance compensation element is, for example, arranged in a through opening of the flap shaft, the flap body contacts an annular contact surface of the tolerance compensation element screwed into the flap shaft, whereby the flap body is attached to the flap shaft via the screw element that is in contact with the flap shaft via a screw head and is screwed into the flap body. The screw element is in this case screwed in so that the flap body is pressed against the circular ring-like contact surface of the tolerance compensation element, wherein, before the screw element is tightened, the circular ring-like contact surface is displaced by adjusting the tolerance compensation element transversely to the longitudinal axis of the flap shaft so that, when the flap body is in the closed position, the sealing surface is in sealing contact with the counter-sealing surface.

The valve body can, for example, comprise a sealing element which is arranged on the sealing surface, wherein, in the closed position, the valve body contacts a counter-sealing surface provided on the flow housing via the sealing surface. The sealing element can, for example, be made of a flexible material, in particular of an elastomer. The seal in the closed position of the valve body can thereby be improved, wherein the sealing element elastically deforms when it contacts the counter-sealing surface and thereby clings particularly well to the counter-sealing surface.

A center plane of the flap body can, for example, be arranged at a distance from a longitudinal axis of the flap shaft, whereby the flap body is arranged eccentrically on the flap shaft. In an embodiment, a longitudinal axis of the flap body can, for example, be additionally arranged at a distance from a transverse axis of the flap shaft, whereby the flap body is attached to the flap shaft in a doubly eccentric manner. This reduces slippage of the sealing surface on the counter-sealing surface during the adjustment process.

The present invention also provides a method for assembling a flap device. The method comprises the steps of:
placing the sealing surface of the flap body against the counter-sealing surface of the flow housing;
mounting the flap shaft on the flow housing;
adjusting the tolerance-compensating element mounted on the flap body until the tolerance-compensating element is in contact with the flap shaft, or adjusting the tolerance-compensating element mounted on the flap shaft until the tolerance-compensating element is in contact with the flap body; and
attaching the flap body to the flap shaft using the fastener.

This provides a flap device with which the manufacturing and assembly tolerances can be compensated in a simple manner and a leakage flow in the closed position of the flap body can be reliably reduced or completely avoided.

An example of a flap device according to the present invention is shown in the drawings and is described below.

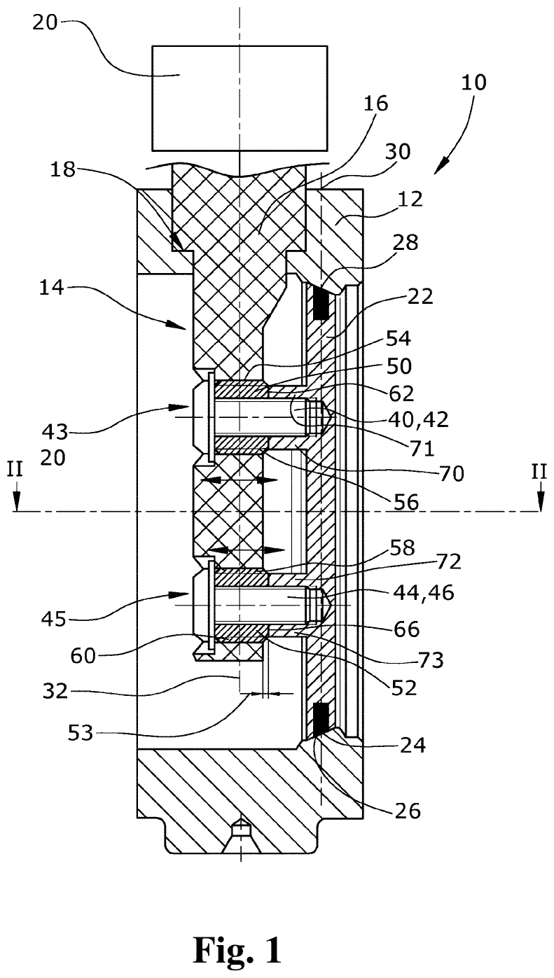

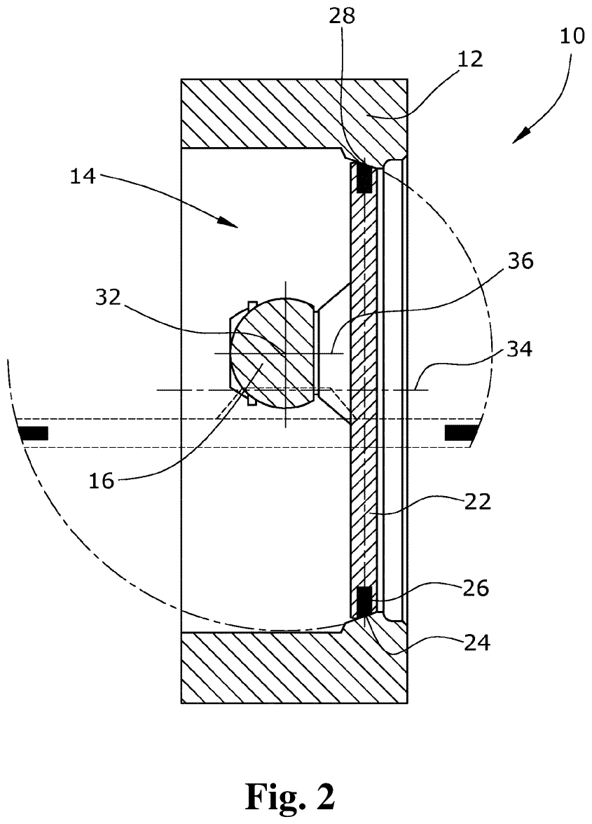

FIGS. 1 and 2 show a flap device 10 for a fuel cell system of a motor vehicle which is used to control an air volume flow or a hydrogen volume flow.

The flap device 10 comprises a flow housing 12 which defines a flow channel 14. A flap shaft 16 projects into the flow channel 14 through an opening 18 formed on the flow housing 12. The flap shaft 16 is rotatably mounted on the flow housing 12, wherein an actuator 20 is connected in a torque-transmitting manner on an end of the flap shaft 16 that projects out of the flow housing 12, whereby the flap shaft 16 can be adjusted in the direction of rotation by the actuator 20. In the present case, the flap shaft 16 is mounted on one side on the flow housing 12. The flap shaft 16 can alternatively also be mounted on both sides on the flow housing 12.

A flap body 22 is attached to a section of the flap shaft 16 which is arranged in the flow channel 14. The flap body 22 is double-eccentric. A flap plane 30 is arranged at a distance from a longitudinal axis 32 of the flap shaft 16. A longitudinal axis 34 of the flap body 22 is arranged at a distance from a transverse axis 36 of the flap shaft 16 which is aligned in the direction of the longitudinal axis 34.

The flap body 22 can be adjusted together with the flap shaft 16 and via the actuator 20 at least between an open position and a closed position. In the open position, the flow channel 14 is open and not blocked by the flap body 22. In the closed position, the flap body 22 sealingly contacts, via a conical sealing surface 24, on which an elastomer sealing element 26 is arranged, on a conical counter-sealing surface 28 which is provided on the flow housing 12. The flow channel 14 is thus closed by the flap body 22 in the closed position.

To provide a seal between the sealing surface 24 and the counter-sealing surface 28 when the flap body 22 is closed, the flap body 22 is positioned relative to the flap shaft 16 with the help of tolerance-compensating elements 50, 52. The flap shaft 16 comprises two through openings 43, 45, in each of which a tolerance compensation element 50, 52 is arranged. The through openings 43, 45 comprise an internal thread 54, 58 on the respective inner circumferential surface. The tolerance compensation elements 50, 52 each comprise an external thread 56, 60 complementary to the respective internal thread 54, 58 so that the tolerance compensation elements 50, 52 can be screwed into the through openings 43, 45. The tolerance compensation elements 50, 52 project out of the through openings 43, 45 on a side facing the flap body 22 and form a circular contact surface 62, 66 against which the flap body 22 is in contact in the fully assembled state.

The tolerance compensation elements 50, 52 are configured in the manner of sleeves, wherein a respective fastening element 40, 44 which is configured as a screw element 42, 46 extends through the through openings 43, 45 and through the sleeve-like tolerance compensation elements 50, 52 and is screwed into the flap body 22. The flap body 22 comprises a protrusion 70, 72 with an internal thread 71, 73 therefor. The protrusions 70, 72 are in particular used for the eccentric attachment of the flap body 22 to the flap shaft 16, wherein the flap body 22 contacts, via the free ends of the protrusions 70, 72, with a respective circular ring-like contact surface 62, 66 of the tolerance compensation elements 50, 52.

When assembling the flap device 10, the flap shaft 16 is first mounted and the flap body 22 is positioned over the contact surface of the sealing surface 24 on the counter-sealing surface 28. The tolerance compensation elements 50, 52 are then screwed into the through openings 43, 45 until the end of the tolerance compensation elements 50, 52 protruding from the through openings 43, 45 annular contact surfaces 62, 66 on the protrusions 70, 72 of the flap body 22 and a gap 53 between the flap shaft 16 and the flap body 22 is bridged. The flap body 22 is thereby clamped between the counter-sealing surface 28 and the tolerance compensation elements 50, 52. Finally, the screw elements 42, 46 are inserted through the through openings 43, 45 and the sleeve-like tolerance compensation elements 50, 52 and screwed into the flap body 22.

A seal in the closed position of the flap body can be provided in a simple and cost-effective manner by such a design of the flap device, wherein the tolerance compensation element can be adjusted individually for each flap device and thus the manufacturing and assembly tolerances of each individual flap device can be reliably compensated.

It should be clear that the scope of protection of the present invention is not limited to the above-described embodiment, but that various modifications are possible. The tolerance compensation elements can in particular also be arranged adjustably on the flap body and the flap shaft can be in contact with the tolerance compensation elements perpendicular to the longitudinal axis of the flap shaft. The tolerance compensation elements can also be arranged on a protrusion instead of in a through opening, wherein the tolerance compensation elements are screwed onto the protrusions. Instead of being attached via a screw connection, the tolerance compensation element can also be configured and mounted so that the tolerance compensation element is positioned in a position bridging the gap between the flap body and the flap shaft and is welded to the flap body or the flap shaft. The tolerance-compensating element could additionally be rigidly attached to the flap body and welded or adhesively bonded to the flap shaft so that the tolerance-compensating element is positioned in a gap-bridging position and welded or adhesively bonded to the flap body or flap shaft. The tolerance-compensating element could likewise be rigidly attached to the flap shaft and adhesively bonded to the flap body, wherein the tolerance-compensating element is also positioned in a gap-bridging position and adhesively bonded to the flap body or the flap shaft. Reference should also be had to the appended claims.

### LIST OF REFERENCE NUMERALS

10 Flap device
12 Flow housing
14 Flow channel
16 Flap shaft
18 Opening
20 Actuator
22 Flap body
24 Sealing surface
26 Elastomer sealing element
28 Counter-sealing surface
30 Flap plane
32 Longitudinal axis of flap shaft 16
34 Longitudinal axis of flap body 22
36 Transverse axis of flap shaft 16
40 Fastening element
42 Screw element
43 Through opening
44 Fastening element
45 Through opening
46 Screw element
50 Tolerance compensation element
52 Tolerance compensation element
53 Gap
54 Internal thread
56 External thread
58 Internal thread
60 External thread
62 Contact surface
66 Contact surface
70 Protrusion
71 Internal thread
72 Protrusion
73 Internal thread

What is claimed is:

1-12 (anceled)

13. A flap device for a fuel cell system, the flap device comprising:
a flow housing which defines at least one flow channel;
a flap shaft which projects into the at least one flow channel, the flap shaft being configured to be rotated by an actuator between a plurality of positions about a longitudinal axis;
a flap body which is arranged in the at least one flow channel and which is attached to the flap shaft, the flap body being configured to be adjusted together with the flap shaft at least between a closed position and an open position; and
a tolerance compensation element,
wherein, during an assembly of the flap device,
the tolerance compensation element is configured so that it can be fastened to the flap shaft in different positions transversely to the longitudinal axis of the flap shaft so as to bridge a gap between the flap shaft and the flap body, the flap body contacting the tolerance compensation element transversely to the longitudinal axis of the flap shaft, or
the tolerance compensation element is configured so that it can be fastened to the flap body in different positions transversely to the longitudinal axis of the flap shaft so as to bridge a gap between the flap shaft and the flap body, the flap shaft contacting the tolerance compensation element transversely to the longitudinal axis of the flap shaft.

14. The flap device as recited in claim 13, wherein,
the tolerance compensation element comprises a thread, and
the flap shaft or the flap body further comprises a counter-thread which is complementary to the thread of the tolerance compensation element so that the tolerance compensation element is adjustable via a rotary movement around a longitudinal axis of the tolerance compensation element.

15. The flap device as recited in claim 14, wherein,
the flap shaft or the flap body comprises a through opening, the through opening comprising a circumferential surface which comprises an internal thread,
the tolerance compensation element is configured to be sleeve-like and is arranged in the through opening of the flap shaft or of the flap body,
the tolerance compensation element further comprises an external thread on an outer circumferential surface thereof, and
the internal thread on the circumferential surface of the through opening is complementary to the external thread on the outer circumferential surface of the tolerance compensation element.

16. The flap device as recited in claim 15, further comprising:
a fastening element which is configured to fasten the tolerance compensation element to the flap shaft or to the flap body,
wherein,
the fastening element is a screw element, and
the screw element is arranged coaxially to tolerance compensation element.

17. The flap device as recited in claim 14, wherein,
the flap body or the flap shaft comprises a protrusion, the protrusion comprising an external thread arranged thereon,
the tolerance compensation element is configured to be sleeve-like and is arranged on the protrusion of the flap body or of the flap shaft,
the tolerance compensation element further comprises an internal thread, and
the internal thread of the tolerance compensation element is complementary to the external thread on the protrusion.

18. The flap device as recited in claim 17, further comprising:
a fastening element which is configured to fasten the tolerance compensation element to the flap shaft or to the flap body,
wherein,
the fastening element is a screw element, and
the screw element is arranged coaxially to tolerance compensation element.

19. The flap device as recited in claim 13, wherein,
the flap body or the flap shaft comprises a through opening or a protrusion, and
the tolerance compensation element is configured to be sleeve-like and is arranged on the protrusion or in the through opening so that the tolerance compensation element is positioned in a position bridging the gap and is welded or adhesively bonded to the flap body or the flap shaft.

20. The flap device as recited in claim 19, further comprising:
a fastening element which is configured to fasten the tolerance compensation element to the flap shaft or to the flap body,
wherein,
the fastening element is a screw element, and
the screw element is arranged coaxially to tolerance compensation element.

21. The flap device as recited in claim 13, wherein
the tolerance compensation element is attached to the flap body and is welded or adhesively bonded to the flap shaft so that the tolerance compensation element is positioned in a position bridging the gap, or
the tolerance compensation element is attached to the flap shaft and is welded or adhesively bonded to the flap body so that the tolerance compensation element is positioned in a position bridging the gap.

22. The flap device as recited in claim 13, wherein,
the flow housing comprises a counter-sealing surface arranged thereon,
the flap body comprises a sealing element which is arranged on a sealing surface, and
in the closed position, the flap body contacts, via the sealing surface, the counter-sealing surface of the flow housing.

23. The flap device as recited in claim 22, wherein the sealing element is made of a flexible material.

24. The flap device as recited in claim 23, wherein the flexible material is an elastomer.

25. The flap device as recited in claim 13, wherein,
the flap body has a center plane, and
the center plane of the flap body is arranged at a distance from the longitudinal axis of the flap shaft.

26. The flap device as recited in claim 13, wherein,
the flap body has a longitudinal axis,
the flap shaft has a traverse axis, and
the longitudinal axis of the flap body is arranged at a distance from the transverse axis of the flap shaft.

27. A method for assembling the flap device as recited in claim 13, the method comprising:
contacting a sealing surface of the flap body with a counter sealing surface of the flow housing;
mounting the flap shaft to the flow housing;
displacing the tolerance compensation element mounted on the flap body until the tolerance compensation element contacts the flap shaft or displacing the tolerance compensation element mounted on the flap shaft until the tolerance compensation element contacts the flap body; and
attaching the flap body to the flap shaft.
